(19) United States
(12) Patent Application Publication
(10) Pub. No.: US 2009/0180512 A1
(43) Pub. Date: Jul. 16, 2009

(54) Compressible Electrode End Face

(76) Inventor: Michael Frastaci, North Royalton, OH (US)

Correspondence Address: WADDEY & PATTERSON, P.C., 1600 DIVISION STREET, SUITE 500, NASHVILLE, TN, 37203, US

(21) Appl. No.: 12/014,835

(22) Filed: Jan. 16, 2008

(51) Int. Cl. H05B 7/06

(52) U.S. Cl. 373/88

(57) ABSTRACT

A graphite electrode having an end face having an integral structure which is compressible when exposed to a torque of at least about 390 Nm which, when employed in an electrode joint, can reduce the tendency of the electrode joint of which it is an element to come unscrewed during furnace operation, and impede oxidation of the joint, without a significant reduction in electrode performance.

### BACKGROUND OF THE INVENTION

1. Technical Field

The present invention relates to a compressible end face for graphite electrodes, for locking and sealing of an electrode joint, and a process for preparing an electrode joint formed with the graphite electrode having a compressible end face. More particularly, the invention concerns a graphite electrode having an end face formed so as to permit compression when joined with an adjoining graphite electrode to form a joint.

2. Background Art

Graphite electrodes are used in the steel industry to melt metals and other ingredients used to form steel in electrothermal furnaces. The heat needed to melt metals is generated by passing current through a plurality of electrodes, usually three, and forming an arc between the electrodes and the metal. Electrical currents in excess of 100,000 amperes are often used. The resulting high temperature melts the metals and other ingredients. Generally, the electrodes used in steel furnaces are present in the form of electrode columns, that is, a series of individual electrodes joined to form a single column. In this way, as electrodes are depleted during the thermal process, replacement electrodes can be joined to the column to maintain the length of the column extending into the furnace.

Generally, electrodes are joined into columns via a pin (sometimes referred to as a nipple) that functions to join the ends of adjoining electrodes. Typically, the pin takes the form of opposed male threaded sections, with at least one end of the electrodes comprising female threaded sections capable of mating with the male threaded section of the pin. Thus, when each of the opposing male threaded sections of a pin are threaded into female threaded sections in the ends of two electrodes, those electrodes become joined into an electrode column. Commonly, the joined ends of the adjoining electrodes, and the pin therebetween, are referred to in the art as a joint (or, more specifically, a pin joint).

Alternatively, the electrodes can be formed with a threaded protrusion or tang machined into one end and a threaded socket machined into the other end, such that the electrodes can be joined by threading the tang of one electrode into the socket of a second electrode, and thus form an electrode column. The joined ends of two adjoining electrodes in such an embodiment is also referred to in the art as a pinless joint.

In the production of a pinless electrode joint, so-called “blocked” threads, also referred to in the industry as “fully jammed” threads, are often employed. In blocked threads, both thread flanks from one of the elements (such as the male tang) is in contact with both thread flanks from the other element (such as the female socket). Contrariwise, in “non-blocked” or “unblocked” threads, referred to in the industry as “jammed” threads, only one thread flank from each element contacts the threads of the other element, and are commonly employed in pin joints.

Given the extreme thermal stress that the electrode and the joint (and indeed the electrode column as a whole) undergoes, mechanical/thermal factors such as strength, thermal expansion, and crack resistance must be carefully balanced to avoid damage or destruction of the electrode column or individual electrodes. For instance, longitudinal (i.e., along the length of the electrode/electrode column) thermal expansion of the electrodes, especially at a rate different than that of the pin, can force the joint apart, reducing effectiveness of the electrode column in conducting the electrical current. A certain amount of transverse (i.e., across the diameter of the electrode/electrode column) thermal expansion of the electrode in excess of that of the pin may be desirable to form a firm connection between pin and electrode; however, if the transverse thermal expansion of the electrode greatly exceeds that of the pin, damage to the electrode or separation of the joint may result. Again, this can result in reduced effectiveness of the electrode column, or even destruction of the column if the damage is so severe that the electrode column fails at the joint section.

Moreover, another effect of the thermal and mechanical stresses to which an electrode column is exposed is literal unscrewing of the electrodes forming the joint (or the electrodes and pins forming the joint), due to vibrations and other stresses. This unscrewing can reduce electrode column efficiency by reducing electrical contact between adjoining electrodes. In the most severe case, unscrewing can result in loss of the electrode column below the affected joint.

In U.S. Pat. No. 3,540,764, Paus and Revilock suggest the use of an expanded graphite spacer disposed between the end faces of adjacent electrodes in order to increase electrical conductivity and thermal stress resistance of the joint. The nature of the Paus and Revilock spacer and its placement, however, is such that a gap is created in the joint where it may not have otherwise been, thereby contributing to joint looseness and potential for failure.

In U.S. Pat. No. 7,206,330, U.S. Patent Application Publication No. US 2007/0047613 and U.S. Patent Application Publication No. US 2007/0127541, different embodiments of a unique end face seal or locking ring for positioning between the end faces of adjoining electrodes in an electrode joint are disclosed. The end face seal or locking ring is formed of a compressible material, especially compressed particles of exfoliated graphite, having a coefficient of friction sufficient to retard unscrewing of the electrodes, especially a spiral wound sheet of compressed particles of exfoliated graphite. In a preferred embodiment, the electrical conductivity of the end face seal or locking ring is greater in the direction extending between the electrodes than it is in the direction orthogonal thereto. The use of the disclosed end face seal or locking ring is effective at retarding undesirable unscrewing of the electrodes forming the joint, and impeding oxidation of the joint. However, some electric arc furnace operators find it inconvenient to have an additional part (the end face seal or locking ring) maintained in inventory and which needs to be applied prior to formation of the electrode joint.

What is desired, therefore, is a graphite electrode having an end face configured to reduce the tendency of an electrode joint of which it is an element to come unscrewed during furnace operation, and impede oxidation of the joint, without a significant reduction in electrode performance, especially without the agency of a locking ring or end face seal. It is also highly desirable to achieve these property benefits without requiring a substantial amount of effort at the electric arc furnace site.

### BREIF DESCRIPTION OF THE INVENTION

It is an aspect of the present invention to provide a graphite electrode having an end face configured to improve performance of a joint formed therewith.

It is another aspect of the present invention to provide a graphite electrode having an end face which reduces or eliminates the tendency of an electrode joint to come unscrewed.

It is yet another aspect of the present invention to provide a graphite electrode having an end face which produces electrode column joints having improved strength and stability.

Still another aspect of the present invention is a graphite electrode joint, having improved resistance to unscrewing as compared to art-conventional graphite electrode joints.

These aspects and others that will become apparent to the artisan upon review of the following description can be accomplished by providing a graphite electrode having an end face having an integral structure or configuration which is compressible when exposed to a torque of at least about 390 Newton-meters (Nm), where the structure or configuration can be a plurality of ridges extending from the surface (i.e., defined as the lowest point of the structure or configuration) of the end face of the graphite electrode to a height of at least about 250 microns, further wherein the ridges each have a tip, and the tips of the plurality of ridges are separated by at least about 3 mm on average, and generally no more than about 30 mm on average, with the specific separation between the ridges varying between about 2.5 and about 30 mm, or where the structure or configuration comprises a plurality of rounded corrugations extending from the surface of the end face of the graphite electrode wherein the corrugations have a rounded top and extend from the surface of the end face of the graphite electrode to a height of at least about 150 microns (more advantageously from about 0.5 mm to about 7 mm in height, and most preferably from about 1 mm to about 5 mm in height) but closer together and more numerous than the ridges (with corrugation tops separated by at least about 1 mm on average, and generally no more than about 20 mm on average, more preferably from about 2 mm to about 6 mm on average) and form concentric grooves. By integral is meant that the structure or configuration is formed into the electrode itself, and is not a separate and independent element.

Alternatively, the structure or configuration comprises an end face forming an acute angle with respect to the sidewall of the graphite electrode, where the angle formed by the end face with respect to the sidewall is less than about 90°, more preferably, where the acute angle formed by the end face with respect to the sidewall is at least about 15°. Most preferably, the angle formed by the end face with respect to the sidewall is an acute angle of greater than 70°, and advantageously between about 75° and about 89°.

In another embodiment, an electrode joint comprising two joined graphite electrodes is presented, wherein at least one of the electrodes has an end face having a structure or configuration which is compressible when exposed to a torque of at least about 390 Nm, as described above. In addition, a process for preparing an electrode joint is also presented, the process including providing a first graphite electrode having an end face having a structure or configuration which is compressible when exposed to a torque of at least about 390 Nm as described above; providing a second graphite electrode; and threadedly engaging the first graphite electrode with the second graphite electrode using a torque of at least about 830 Nm, more preferably where the torque is about 830 Nm to about 8000 Nm.

It is to be understood that both the foregoing general description and the following detailed description provide embodiments of the invention and are intended to provide an overview or framework of understanding and nature and character of the invention as it is claimed. The accompanying drawings are included to provide a further understanding of the invention and are incorporated in and constitute a part of the specification. The drawings illustrate various embodiments of the invention and together with the description serve to describe the principles and operations of the invention.

### BRIEF DESCRIPTION OF THE DRAWINGS

FIG. 1 is a partial top perspective view of one embodiment of a graphite electrode in accordance with the present invention.

FIG. 2 is a partial cross sectional view of the graphite electrode of FIG. 1, taken along lines 2-2.

FIG. 3 is a partial top perspective view of a second embodiment of a graphite electrode in accordance with the present invention.

FIG. 4 is a partial cross sectional view of the graphite electrode of FIG. 3, taken along lines 4-4.

FIG. 5 is a partial top perspective view of a third embodiment of a graphite electrode in accordance with the present invention.

FIG. 6 is a partial cross sectional view of the graphite electrode of FIG. 5, taken along lines 6-6.

FIG. 7 is a partial side plan view of an electrode joint formed with the electrode of FIG. 1 in accordance with the present invention.

FIG. 8 is a partial side plan view of an electrode joint formed with the electrode of FIG. 3 in accordance with the present invention.

### DETAILED DESCRIPTION OF THE PREFERRED EMBODIMENT

Graphite electrodes can be fabricated by first combining a particulate fraction comprising calcined coke, pitch and, optionally, mesophase pitch or PAN-based carbon fibers into a stock blend. More specifically, crushed, sized and milled calcined petroleum coke is mixed with a coal-tar pitch binder to form the blend. The particle size of the calcined coke is selected according to the end use of the article, and is within the skill in the art. Generally, in graphite electrodes for use in processing steel, particles up to about 25 millimeters (mm) in average diameter are employed in the blend. The particulate fraction preferable includes a small particle size filler comprising coke powder. Other additives that may be incorporated into the small particle size filler include iron oxides to inhibit puffing (caused by release of sulfur from its bond with carbon inside the coke particles), coke powder and oils or other lubricants to facilitate extrusion of the blend.

After the blend of particulate fraction, pitch binder, etc. is prepared, the body is formed (or shaped) by extrusion though a die or molded in conventional forming molds to form what is referred to as a green stock. The forming, whether through extrusion or molding, is conducted at a temperature close to the softening point of the pitch, usually about 100° C. or higher. The die or mold can form the article in substantially final form and size, although machining of the finished article is usually needed, at the very least to provide structure such as threads. The size of the green stock can vary; for electrodes the diameter can vary between about 220 mm and 700 mm.

After extrusion, the green stock is heat treated by baking at a temperature of between about 700° C. and about 1100° C., more preferably between about 800° C. and about 1000° C., to carbonize the pitch binder to solid pitch coke, to give the article permanency of form, high mechanical strength, good thermal conductivity, and comparatively low electrical resistance, and thus form a carbonized stock. The green stock is baked in the relative absence of air to avoid oxidation. Baking should be carried out at a rate of about 1° C. to about 5° C. rise per hour to the final temperature. After baking, the carbonized stock may be impregnated one or more times with coal tar or petroleum pitch, or other types of pitches or resins known in the industry, to deposit additional coke in any open pores of the stock. Each impregnation is then followed by an additional baking step.

After baking, the carbonized stock is then graphitized. Graphitization is by heat treatment at a final temperature of between about 2500° C. to about 3400° C. for a time sufficient to cause the carbon atoms in the coke and pitch coke binder to transform from a poorly ordered state into the crystalline structure of graphite. Advantageously, graphitization is performed by maintaining the carbonized stock at a temperature of at least about 2700° C., and more advantageously at a temperature of between about 2700° C. and about 3200° C. At these high temperatures, elements other than carbon are volatilized and escape as vapors. The time required for maintenance at the graphitization temperature using the process of the present invention is no more than about 18 hours, indeed, no more than about 12 hours. Preferably, graphitization is for about 1.5 to about 8 hours. Once graphitization is completed, the finished article can be cut to size and then machined or otherwise formed into its final configuration.

In order to improve the functioning of an electrode joint, more specifically to reduce the tendency of an electrode joint to come unscrewed during furnace operation, and impede oxidation of the joint, without a significant reduction in performance, especially without a locking ring or end face seal interposed between the end faces of the electrodes in the joint, one or both of the electrodes should have an end face configured to provide compressibility when the joint is formed. By “end face,” it is meant the surface at the end of an electrode, which is found between the outer circumference of the electrode and the socket or tang (in an electrode used in a pinless joint). End faces of adjoining electrodes in a joint are opposed to each other; in joints utilizing unblocked threads, as described above, the end faces of adjoining electrodes commonly meet whereas in joints utilizing blocked threads, there commonly exists a gap between the end faces of adjoining electrodes. Joints utilizing either blocked threads or unblocked threads are within the contemplation hereof.

To provide the desired compressibility to the end face of an electrode, the end face should be configured such that, as the electrode having a compressible end face is mated to an adjoining or second electrode, the compressible end face abuts the end face of the second electrode and the compressible structures are compressed in response to the torque applied in threading the two electrodes together to form the joint. The compression at the end face of one or both of the electrodes threaded together to form the joint creates a joint which is frictionally impeded from unscrewing to a greater extent than conventional joints which do not have compressible structures between the end faces of the joint, and help to reduce or retard oxidation of the interior portions of the joint (especially at the threads); oxidation can lead to joint failure.

In order to provide a compressible end face for an electrode, a compressible structure (sometimes referred to as configuration) must be formed in the end face, generally by machining. Indeed, the compressible structure can be machined into the end face of the electrode during machining of the electrode into its final configuration. The compressible structure or configuration provided in the end face of a graphite electrode is such that compression occurs when the torque applied to the compressible structure or configuration is at least about 390 Nm. In other words, the torque necessary to cause compression of the compressible structure or configuration is advantageously at least about 390 Nm, but which should preferably be no greater than the torque normally applied when forming an electrode joint, and greater than the force applied to the compressible structure or configuration during machining, storage, shipping and normal handling. More preferably, the torque necessary to cause compression of the compressible structure or configuration should be at least about 830 Nm, and most preferably from about 830 Nm to about 8000 Nm.

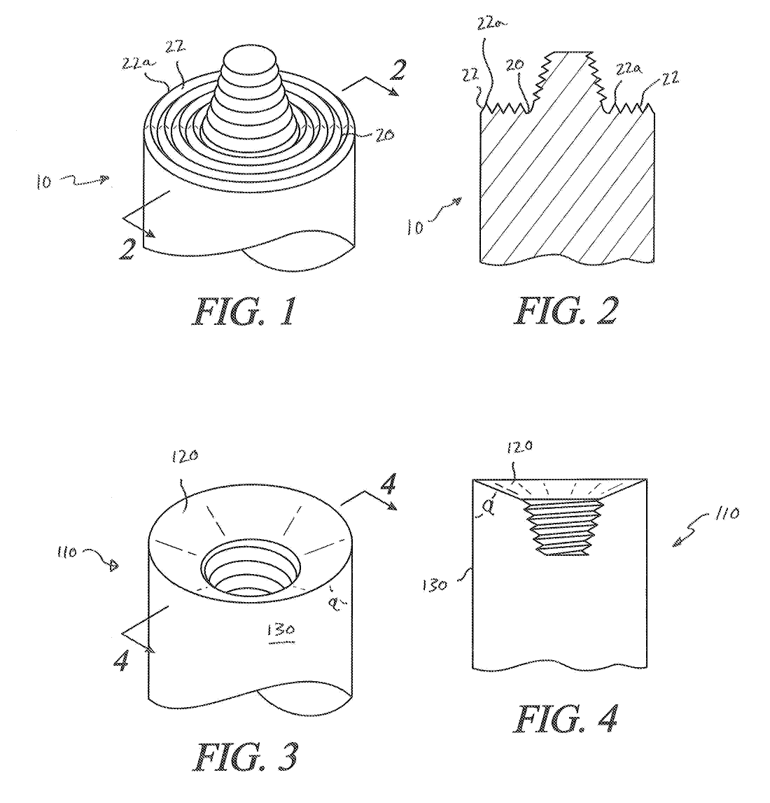

While many structures can be employed to provide compressibility to the end face of an electrode, two have been found particularly suitable. More specifically, and referring now to FIGS. 1 and 2, a graphite electrode in accordance with the present invention is designated by the reference numeral 10. In one preferred embodiment, graphite electrode 10 has a pattern of ridges 22 machined into the end face 20 thereof. Preferably, the compressible structure is ridges 22, which are each machined into end face 20 such that they are at least about 250 microns in height, more advantageously from about 1 mm to about 10 mm in height, and most preferably from about 3 mm to about 8 mm in height, and assume a generally triangular shape with the tips 22a of ridges 22 separated by at least about 3 mm on average, and generally no more than about 30 mm on average, more preferably from about 4 mm to about 8 mm on average. The specific separation between ridges 22 should vary between about 2.5 and about 30 mm, more preferably between about 3 mm and about 25 mm.

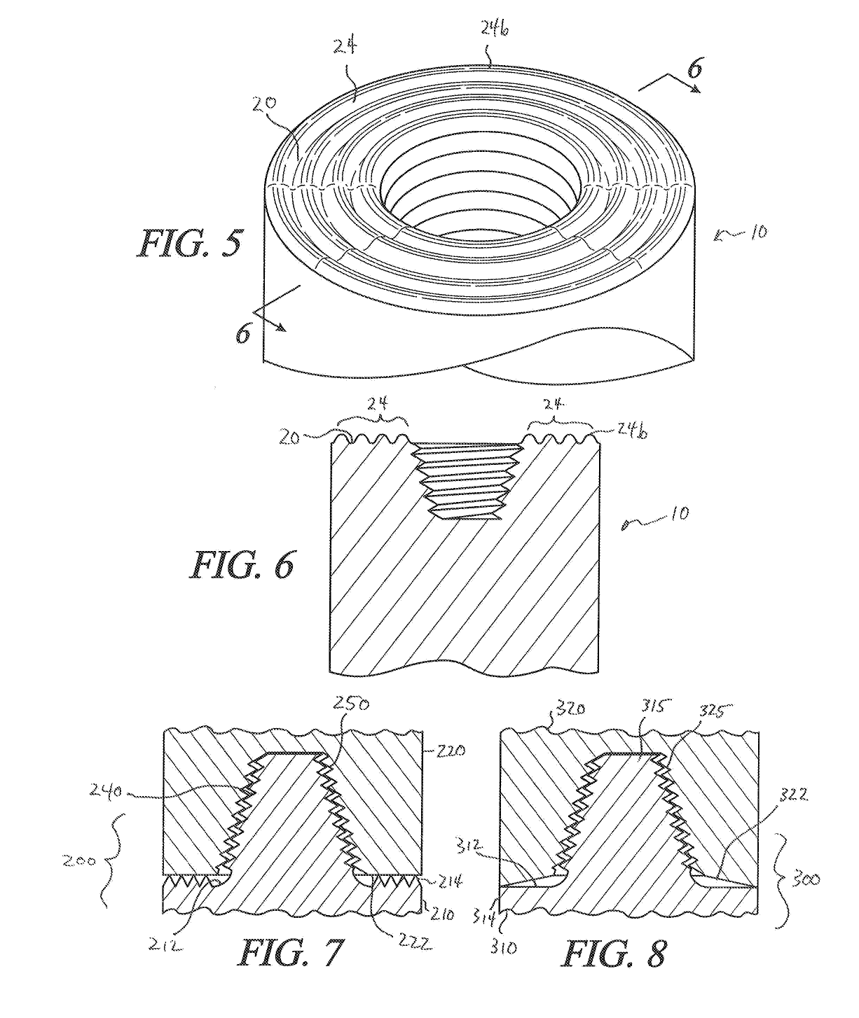

Alternatively, as illustrated in FIGS. 5 and 6, end face 20 of electrode 10 has a pattern of corrugations 24 machined thereinto, which are more rounded, lower in height (i.e., at least about 150 microns, more advantageously from about 0.5 mm to about 7 mm in height, and most preferably from about 1 mm to about 5 mm in height) but closer together and more numerous than ridges 22, with corrugation tops 24b separated by at least about 1 mm on average, and generally no more than about 20 mm on average, more preferably from about 2 mm to about 6 mm on average. The specific separation between corrugation tops 24b should vary between about 1.5 and about 20 mm, more preferably between about 2 mm and about 20 mm) and form concentric grooves.

If desired, a ramming paste, cement or other putty-like material (not shown) can be positioned between ridges 22 or corrugations 24, to further improve resistance to oxidation, to dampen vibrations, and the like.

Another embodiment found to be effective at permitting compression between the end faces of adjoining electrodes in an electrode joint, illustrated in FIGS. 3 and 4, is where an end face 120 of a graphite electrode 110 is provided with an acute angle (denoted a) with respect to sidewall 130 of electrode 110. In other words, conventional electrodes are machined such that the end face forms a generally right angle with the sidewalls of the electrode. In forming the inventive electrode 110 with an end face 120 forming an acute angle a with respect to sidewall 130, the outer portion of end face 120 contacts the outer portion end face of the electrode with which inventive electrode 110 is being joined to form a joint and are compressed down as the joint is formed (provided the preferred amount of torque is applied). Preferably, the angle a formed between end face 120 and sidewall 130 of electrode 110 is less than about 90°, more preferably, where the angle is at least about 15°. Most preferably, the angle a formed by the end face with respect to the sidewall is an acute angle of greater than 70°, and advantageously between about 75° and about 89°.

As noted above, the compressible structure or configuration can be on the end face of one of the electrodes from which a joint is formed; contrariwise, the end faces of both electrodes forming the joint can be provided with a compressible structure. Likewise, both ends of a graphite electrode can be provided with a compressible structure, to provide additional flexibility to the operator of an electric arc furnace.

In forming a joint 200 in accordance with the present invention, as illustrated in FIG. 7, a first graphite electrode 210, having a compressible structure or configuration in the form of ridges 214 on an end face 212 thereof, is threadedly joined with a second electrode 220, which can but does not necessarily have an end face having a compressible structure thereon. The electrodes can be joined via a pin (not shown), where both electrodes have a female socket machined therein; alternatively, one of the electrodes (in this case 210) can have a threaded male tang 240 machined into an end thereof, which threadedly engages a female socket 250 machined into the other electrode (in this case 220). When joint 200 is formed, ridges 214 contact the end face 222 of second electrode 220, and are compressed by the action of the torque applied to threadedly engage electrode 210 and electrode 220.

Alternatively, in forming a joint 300 in accordance with the present invention, as illustrated in FIG. 8, a first graphite electrode 310, having an end face 312 which forms an acute angle with respect to the sidewall 314 of electrode 310, is threadedly joined with a second electrode 320, which can but does not necessarily have an end face having a compressible structure thereon. Again, the electrodes can be joined via a pin (not shown), where both electrodes have a female socket machined therein; alternatively, one of the electrodes 310 can have a threaded male tang 315 machined into an end thereof, which threadedly engages a female socket 325 machined into the other electrode 320. When joint 300 is formed, end face 312 contacts the end face 322 of second electrode 320, and is compressed by the action of the torque applied to threadedly engage electrode 310 and electrode 320.

Thus, by providing a compressible structure or configuration on an end face of one or more of the graphite electrodes used to form a joint, a graphite electrode joint having improved characteristics is provided, without the need for or use of a locking ring or friction layer.

The disclosures of all cited patents and publications referred to in this application are incorporated herein by reference in their entirety.

The above description is intended to enable the person skilled in the art to practice the invention. It is not intended to detail all of the possible variations and modifications that will become apparent to the skilled worker upon reading the description. It is intended, however, that all such modifications and variations be included within the scope of the invention that is defined by the following claims. The claims are intended to cover the indicated elements and steps in any arrangement or sequence that is effective to meet the objectives intended for the invention, unless the context specifically indicates the contrary.

What is claimed is:

1. A graphite electrode having an end face having an integral structure which is compressible when exposed to a torque of at least about 390 Nm.

2. The graphite electrode of claim 1, wherein the structure comprises a plurality of ridges extending from the surface of the end face of the graphite electrode.

3. The graphite electrode of claim 2, wherein the ridges extend from the surface of the end face of the graphite electrode to a height of at least about 250 microns.

4. The graphite electrode of claim 2, wherein the ridges each have a tip, and the tips of the plurality of ridges are separated by at least about 3 mm on average.

5. The graphite electrode of claim 1, wherein the structure comprises a plurality of rounded corrugations extending from the surface of the end face of the graphite electrode.

6. The graphite electrode of claim 5, wherein the corrugations extend from the surface of the end face of the graphite electrode to a height of at least about 150 microns.

7. The graphite electrode of claim 5, wherein the corrugations each have a rounded top, and the rounded tops of the plurality of corrugations are separated by at least about 1 mm on average.

8. The graphite electrode of claim 1, wherein the structure comprises an end face forming an acute angle with respect to the sidewall of the graphite electrode.

9. The graphite electrode of claim 8, wherein the acute angle formed by the end face with respect to the sidewall is greater than about 70°.

10. The graphite electrode of claim 9, wherein the acute angle formed by the end face with respect to the sidewall is between about 75° and about 89°.

11. An electrode joint comprising two joined graphite electrodes, wherein at least one of the electrodes has an end face having a structure which is compressible when exposed to a torque of at least about 390 Nm.

13. The electrode joint of claim 11, wherein the structure comprises a plurality of ridges extending from the surface of the end face of the graphite electrode.

14. The electrode joint of claim 11, wherein the structure comprises a plurality of rounded corrugations extending from the surface of the end face of the graphite electrode.

15. The electrode joint of claim 11, wherein the structure comprises an end face forming an acute angle with respect to the sidewall of the graphite electrode.

16. The electrode joint of claim 15, wherein the acute angle formed by the end face with respect to the sidewall is greater than about 70°.

17. A process for preparing an electrode joint, the process comprising providing a first graphite electrode having an end face having a structure which is compressible when exposed to a torque of at least about 390 Nm; providing a second graphite electrode; and threadedly engaging the first graphite electrode with the second graphite electrode using a torque of at least about 390 Nm.

18. The process of claim 17, wherein the torque is about 830 Nm to about 8000 Nm.

19. The process of claim 17, wherein the compressible structure on the end face of the first graphite electrode comprises a plurality of ridges extending from the surface of the end face of the first graphite electrode.

20. The process of claim 17, wherein the compressible structure on the end face of the first graphite electrode comprises an end face forming an acute angle with respect to the sidewall of the first graphite electrode.
